(19) United States
(12) Patent Application Publication
(10) Pub. No.: US 2002/0169976 A1
(43) Pub. Date: Nov. 14, 2002

(54) Enabling optional system features

(76) Inventors: Todd A. Schelling, Irmo, SC (US); Mahesh S. Natu, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/853,825

(22) Filed: May 10, 2001

(51) Int. Cl. H04L 9/32

(52) U.S. Cl. 713/200

(57) ABSTRACT

Optional features of a computer system are enabled securely. Examples of the system features generally include number of processors, processor speed, memory size, and bus speed. A BIOS (Basic Input/Output System) of the system receives encrypted feature packets from a manufacturer of the system, decrypts, authenticates, and verifies the packets, and stores the decrypted packets in a secure, non-volatile storage. When the system is rebooted, the BIOS enables the optional system features as specified in the feature packets. Accordingly, the optional system features are enabled in a secure manner.

### TECHNICAL FIELD

This invention relates to enabling optional system features.

### BACKGROUND

The BIOS (Basic Input/Output System) of a computer is a collection of low-level, machine dependent software that serves to isolate an operating system (e.g., MS-DOS on a personal computer) from the details of the hardware. For example, the BIOS includes procedural calls that read from and write to an absolute disk address, read a character from the keyboard, and write a character to the screen. The BIOS is typically placed on a non-volatile memory chip, e.g., ROM (Read-Only Memory), flash memory, and EEPROM (Electrically Erasable Programmable ROM), supplied by a computer manufacture. The contents of the non-volatile chip are not affected when the computer is powered off. The BIOS is usually stored separately from the OS (Operating System) of the computer to allow independent upgrade of the OS and the BIOS.

Because BIOS of newer versions can be developed during the life span of a computer, it may be necessary to upgrade the BIOS for enhanced performance. Therefore, most modern personal computers store the BIOS on a re-writable memory chip. In particular, a flash memory chip is most often adopted because of its simplicity in use and efficiency to update.

Some computer manufacturers add a RAM (Random Access Memory) for use by the BIOS because RAMs are in general faster than most of the non-volatile memory chips. Each time the computer is rebooted, the BIOS is copied from the non-volatile memory chip to the RAM to accelerate operations of the BIOS. The copying procedure is also known as a “shadowing” procedure.

When a computer is turned on, or rebooted, the BIOS is read and executed by a pre-determined rebooting process. In particular, a bootstrap procedure in the BIOS is executed. The bootstrap procedure carries out hardware tests to ensure that the computer is ready for executing user commands. The BIOS also reads from a diskette, a hard drive, or other storage devices when further information is required for rebooting the computer. Thus, by using the BIOS to reboot the computer and handling input/output operations, hardware details of the computer are hidden from users and high-level software.

### DESCRIPTION OF DRAWINGS

FIG. 1 shows using a BIOS to enable optional system features; and

FIG. 2 shows a process for enabling the optional system features.

### DETAILED DESCRIPTION

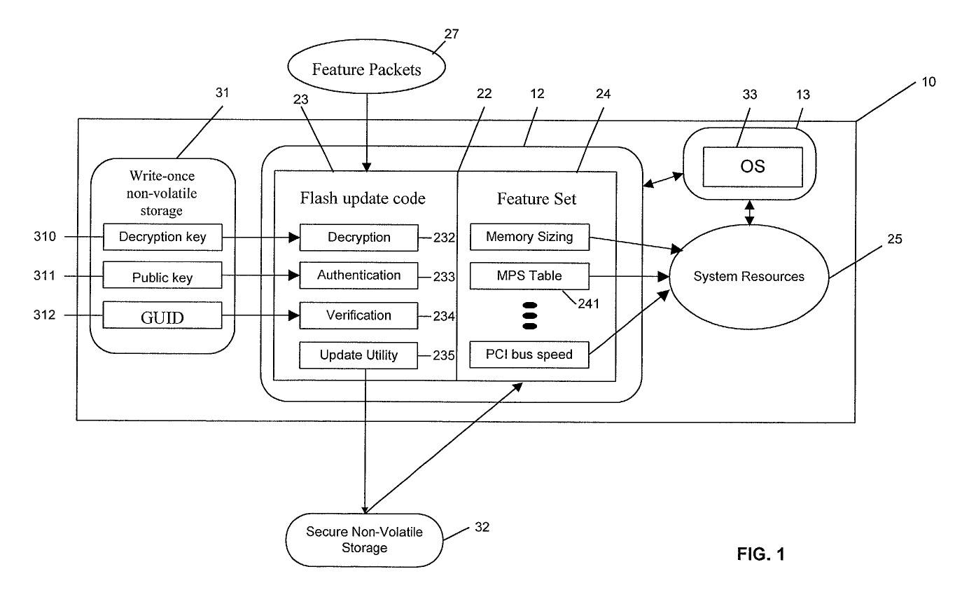

Referring to FIG. 1, a processing system 10 includes a BIOS memory 12, an OS (Operating System) memory 13, and system resources 25. OS memory 13 stores an OS 33, which manages system resources 25 and contains high-level software to provide a user-friendly programming environment. BIOS memory 12 stores a BIOS 22, which is a collection of device drivers that allow users of system 10 and OS 33 to interact with the hardware of the system, but hide machine-dependent details from them. An exemplary memory for BIOS memory 12 is a flash memory, which is re-writable. System resources 25 includes elements of system 10 that contribute to processing power, storage capacity, redundancy, and speed, e.g., memory, input/output devices, processors, redundant power supplies, and PCI (Peripheral Component Interconnect) bus.

Some of system resources 25 have system features that can be optionally selected or configured on an as-needed basis. The features generally include on/off status of the elements of system 10 and adjustable parameters of these elements, e.g., memory size, number of processors, number of PCI slots, PCI bus speed, number of redundant power supplies, and processor speed.

In certain scenarios, it is desirable to selectively enable some of the system features as needed for run-time usage. For example, a manufacturer, e.g., an OEM (Original Equipment Manufacturer), can produce computer systems with the same number of processors. When an end-user purchases one of the computer systems but only uses a few of the processors for performing tasks, the OEM can enable the number of processors as needed by the user. In general, the OEM can produce computer systems with uniform resources and configurations, and can enable the system features selectively after client needs and cost options are determined. The capability of enabling optional system features can be useful in situations where an end-user wants to rent or lease system capacity, performance, or manageability as an alternative to outright purchasing these features. This capability can also be useful when a system provider wishes to reduce the number of available stocked computers, each having different system features, for a given hardware/software set. The number of different stocked computers can be reduced by differentiating the identical computers by enabling different system features. Furthermore, this capability also allows end-users to update or upgrade system capacity or system features without opening the system.

The capability of enabling optional system features is preferably secure, because the OEM may not want the system features to be enabled without authorization. For security purposes, system 10 includes a write-once non-volatile storage 31. Storage 31 is protected from write and erase operations. For example, storage 31 can be a flash memory protected by chipset options, e.g., SMI (System Management Interrupt) protection. The SMI is a special and high-priority interrupt in a PC AT bus architecture that prevents any non-BIOS software application from writing or erasing storage 31.

Storage 31 stores a decryption key 310, a public key 311, and GUID 312 (Globally Unique Identifier). GUID 312 is a long identifier, e.g., 128 bytes, which uniquely identifies system 10. BIOS 22 uses the above contents of storage 31 to implement a secure environment; specifically, the secure environment guarantees authenticity, privacy, and validation of messages from the OEM. The secure environment assures that a message from the OEM for enabling system features will be received and processed in a secure manner.

A BIOS-based control mechanism, as will be described in detail below, is used to provide the capability of enabling optional system features in a secure manner. BIOS 22 includes a flash update code 23 that accesses the contents of storage 31. BIOS 22 also includes a feature set 24 where status of the system features are recorded. In one embodiment, BIOS update code 23 includes a decryption function 232 that decrypts the message sent from the OEM, an authentication function 233 that authenticates a digital signature of the message, a verification function 234 that verifies the message, and a flash update utility 235 that updates a secure non-volatile storage 32. Operations of flash update code 23 will be discussed in detail below.

When the OEM of system 10 wishes to enable certain features of the system, the OEM sends a message to BIOS 22. The message can be transmitted to BIOS 22 in a number of ways, for example, through a network in the form of “feature packets” 27, on a floppy diskette inserted into a floppy drive of system 10, using a file copy, or by electronic mail. Regardless how the message is transmitted to BIOS 22, it is important that the authenticity, validity, and privacy when appropriate, of the message be guaranteed. The authenticity, validity, and privacy of the feature packet's content are protected by encryption and digital signature. Because of the protection of the encryption and digital signature, it is not required that the message be transmitted via secure mechanisms. The BIOS 22 at the final destination of the feature packet (i.e., system 10) can perform complete authentication and validation of the feature packet's content regardless of the transmission medium and/or number of time the feature packet is transferred. Furthermore, the privacy of the feature packet's content is guaranteed at all times as a result of the encryption.

Specifically, when the OEM sends the message to BIOS 22, the OEM generates a digital signature with a private key known only to the OEM. The digital signature is attached to the message to assure the recipient (i.e., BIOS 22) that the message is from an authentic sender. When BIOS 22 receives the message, authentication function 233 uses a public key 311 to confirm that the digital signature is correct, valid, and has not been tampered with. If the content of the message also requires privacy, the OEM can encrypt the message with an encryption key using an encryption algorithm (e.g., 128-bit RSA) to guarantee privacy of the message. When BIOS 22 receives the message, decryption function 232 uses decryption key 310, which is known only to system 10, to decrypt the received message. The encryption ensures that the message will not be meaningful to anyone other then the intended recipient.

In addition to authenticity and privacy, the recipient also needs to verify that it is indeed the intended recipient of the message. Therefore, the message from the sender also includes an identifier that will be verified against GUID 312. Only the message with an identifier matching the GUID of system 10 will be processed by BIOS 22.

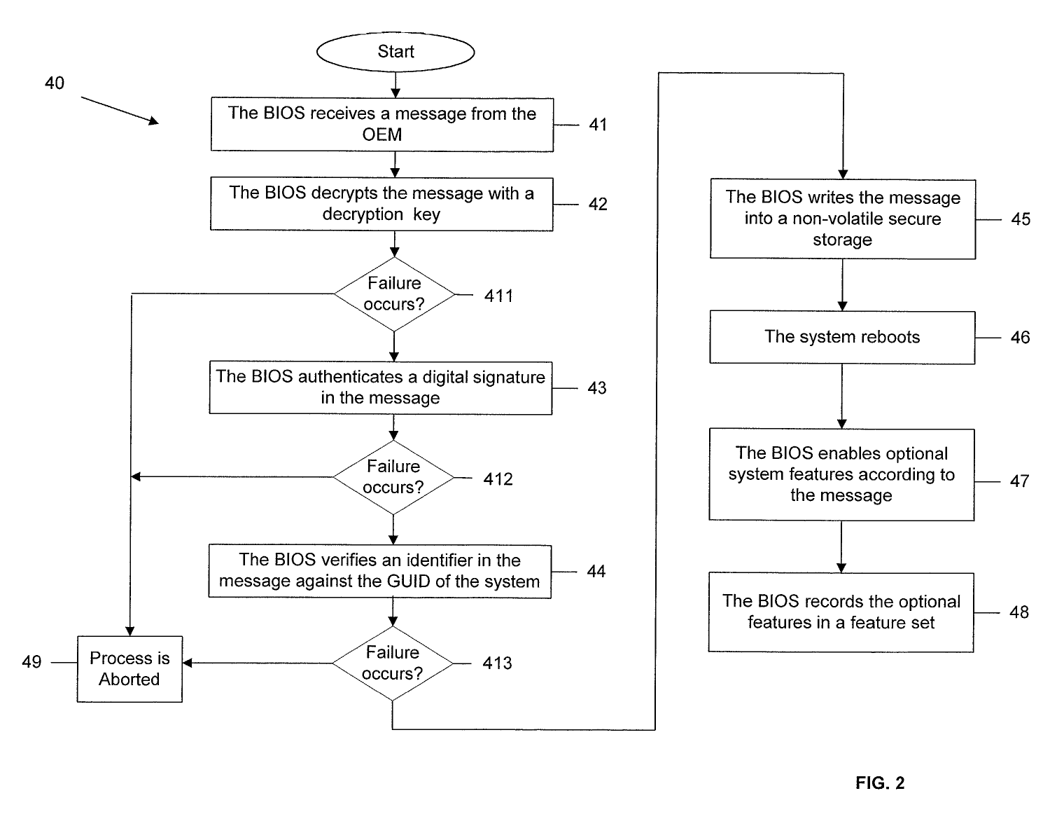

Referring to FIG. 2, an example of a process 40 is shown for enabling optional system features of system resources 25. BIOS 22 receives a message from the OEM, for example, in the form of feature packets 27 arriving from a network connected to system 10 (block 41). If the message is encrypted, decryption function 232 decrypts the message using decryption key 310 (block 42). Authentication function 233 authenticates the digital signature in the message using public key 311 (block 43). Verification function 234 verifies the identifier in the message against GUID 312 (block 44). If failure occurs (blocks 411, 412, and 413) during the decryption, authentication, or verification, process 40 is aborted, and the message is discarded (block 49).

If no failure occurs, in one scenario, BIOS 22 executes flash update utility 235 to write the message into a secure non-volatile storage 32 (block 45), which only accepts inputs from a trusted source, e.g., BIOS 22. System 10 is then rebooted (block 46). During the rebooting process, BIOS 22 retrieves the information in storage 32 and executes according to the information to enable optional system features (block 47). BIOS 22 then records the optional system features in feature set 24 (block 48).

It should be noted that while reboot at block 46 is shown in process 40, in certain scenarios, system 10 does not need to be rebooted. With appropriate stack support from OS 33 and software, system 10 can continue to operate while the system features are being enabled. However, one benefit of rebooting the system is that the current OS 33 and hardware can be used in this BIOS-based control mechanism without modifications.

At block 45 of process 40, secure non-volatile storage 32 can be connected to system 10 either locally, or remotely via network links. Storage 32 serves as a database that stores the decrypted and validated message from the OEM. Only a trusted source, e.g., BIOS 22, can write or erase the contents of storage 32. In one embodiment, storage 32 identifies BIOS 22 as the trusted source, and accepts any input coming from BIOS 22. In another embodiment, BIOS 22 encrypts the message before it is sent to storage 32, and storage 32 decrypts the message in the same manner as performed by decryption function 232. Other techniques for ensuring the trust between BIOS 22 and storage 32 are also possible. Examples of storage 32 include a flash memory, an EEPROM, and a disk, or any other device that is secure, non-volatile, and re-writable.

In certain scenarios, BIOS 22 does not need to write the message to storage 32, and therefore can skip block 45 of process 40. For example, if the message from the OEM contains BIOS-executable code, BIOS 22 can splice the code into its normal execution path, thus effectively modifying itself or erasing part of itself in response to the message. This “splicing” approach is better suited for controlling system features such as number of processors or memory sizes. In another approach, the message from the OEM can include executable code that can be used as DLL (Dynamically Loaded Library). The code is stored in a flash portion of system 10, and is loaded by BIOS 22 at run-time. The “DLL” approach allows BIOS 22 to patch itself with the new executable code, and is better suited for adding large new functionalities such as adding hot-plug CPU (Central Processing Unit) support, or hot-plug memory support.

In embodiments where processing system 10 includes multiple processors, feature set 24 includes an MPS (Multiple Processor Specification) table 241 for storing features related to the multiple processors, e.g., number of processors, processing speed of each of the processors, and so forth. For example, assume that the message from the OEM specifies that only a few of the processors in system 10 will be authorized and enabled. In one scenario, BIOS 22 disables the un-authorized processors by a sequence of actions in an implementation-specific manner. The sequence of actions may include asserting the FLUSH# during a reset, asserting the STP_CLK#, omitting the processors from the MPS and/or ACPI (Advanced Configuration and Power management Interface) processor tables. Once system 10 has been fully rebooted, all the authorized processors will be enabled. The status of the enabled/disabled processors is then recorded in MPS table 241 of feature set 24.

In certain scenarios, if any of the specified processors fail in the above multiple-processor embodiments, BIOS 22 can detect these failed processors and enable spare processors to ensure the correct number of processors being enabled whenever possible.

Other optional system features that can be controlled by the BIOS-based control mechanism include, e.g., amount of system memory, number of powered PCI slots, speed of processors, speed of specific PCI buses, as well as enabling serviceability features, embedded PCI devices such as SCSI (Small Computer System Interface), video, LAN (Local Area Network), peripheral ports such as parallel, USB (Universal Serial Bus) keyboard, mouse, hot-plug PCI, and hot-plug CPU or memory nodes. Even OS level application features can be enabled by the BIOS-based control mechanism in a substantially the same manner. Although some of these features can be enabled directly from system 10 without the feature packets from the OEM, some of the features are so complicated that direct enabling may be infeasible. These complicated features are generally implementation-specific so that a third party agent, e.g., a computer distributor, cannot practically enable the system features without detailed knowledge of the hardware. Therefore, the BIOS-based control mechanism for enabling optional system features, as described above, also has an advantage for simplifying configuration procedures for the parties that do not possess comprehensive knowledge of the hardware.

Other embodiments are within the scope of the following claims.

What is claimed is:

1. A method comprising:
receiving, at a BIOS, a message from an authorized party;
authenticating the message; and
controlling a state of a feature of a system resource, using the BIOS, according to the message.

2. The method of claim 1 further comprising verifying an identifier in the message against a unique system identifier of the system.

3. The method of claim 1 further comprising writing the message into a secure non-volatile location.

4. The method of claim 3 wherein the secure non-volatile location comprises a remote storage.

5. The method of claim 1 further comprising splicing the content of the message into an execution path of the BIOS.

6. The method of claim 1 further comprising loading and executing content of the message using the BIOS at run-time.

5. The method of claim 1 further comprising updating a feature set of the BIOS according to the message.

6. A system comprising:
a system resource having controllable features;
a non-volatile memory that stores a BIOS, the BIOS being adapted to receive a secure message from an authorized party for controlling at least one of the features.

7. The system of claim 6 further comprising a write-once non-volatile unit for storing a public key accessible by the BIOS.

8. The system of claim 6 wherein the BIOS includes authentication circuitry for authenticating the secure message with a public key.

9. The system of claim 6 further comprising a write-once non-volatile unit for storing a unique system identifier accessible by the BIOS.

10. The system of claim 6 wherein the BIOS also includes verification circuitry for verifying an identifier in the message against a unique system identifier.

11. The system of claim 6 further comprising a secure non-volatile location for storing the at least one of the optional features to be enabled, the location being readable and writable by the BIOS.

12. The system of claim 11 wherein the location comprises go a remote storage.

13. The system of claim 6 wherein the BIOS also includes a feature set that is updated according to content of the secure non-volatile storage.

14. The system of claim 6 wherein the BIOS also includes a feature set that is updated according to content of the secure non-volatile storage.

15. The system of claim 6 wherein the BIOS loads and executes the content of the message at run-time.

16. A computer program product residing on a computer readable medium comprising instructions for causing a computer to:
receive, at a BIOS, a message from an authorized party;
authenticate the message; and
control a state of a feature of a system resource, using the BIOS, according to the message.

17. The computer program product of claim 16 further comprising instructions for causing a computer to verify an identifier in the message against a unique system identifier of the system.

18. The computer program product of claim 16 further comprising instructions for causing a computer to write the message into a secure non-volatile location.

19. The computer program product of claim 18 wherein the secure non-volatile location comprises a remote storage.

20. The computer program product of claim 16 further comprising instructions for causing a computer to splice the content of the message into a n execution path of the BIOS.

21. The computer program product of claim 16 further comprising instructions for causing a computer to load and execute the content of the message at the BIOS at run-time.

22. The computer program product of claim 16 further comprising instructions for causing a computer to update a feature set of the BIOS according to the message.
